(19) United States
(12) Patent Application Publication
(10) Pub. No.: US 2009/0021394 A1
(43) Pub. Date: Jan. 22, 2009

(54) ALTAVIEW SYSTEM

(76) Inventor: Daniel J. Coughlin, Lake Mary, FL (US)

Correspondence Address: ORTIZ & LOPEZ, PLLC, P.O. BOX 4484, ALBUQUERQUE, NM, 87196-4484, US

(21) Appl. No.: 12/045,843

(22) Filed: Mar. 11, 2008

Related U.S. Application Data
(60) Provisional application No. 60/951,136, filed on Jul. 20, 2007.

(51) Int. Cl. H04Q 9/00

(52) U.S. Cl. 340/870.07

(57) ABSTRACT

Telemetry signals and biometric telemetry signals are wirelessly transmitted from an athlete, driver, or other person over an audio/video link. The measurement stream from a sensor can be modulated and then fed into a transmitter's audio input or video input. The transmitter transmits a signal containing the measurement stream as well as audio and video streams. A demodulator recovers the measurement stream output by a receiver receiving the signal. The recovered measurement signal can then be passed to an interested party. For example, a heart rate measurement can be obtained from a driver or other athlete and displayed to a television audience.

### CROSS REFERENCE TO RELATED APPLICATIONS

This patent application claims the priority and benefit of U.S. Provisional Patent Application No. 60/951,136 filed Jul. 20, 2007 entitled “AltaView System” which is herein incorporated by reference.

### TECHNICAL FIELD

Embodiments relate to television, audio/video (A/V) systems, and A/V transmissions. Embodiments also relate to sensors and sensing systems such as biometric sensors and sensing systems. Embodiments additionally relate to data transmission.

### BACKGROUND OF THE INVENTION

Audio/video (A/V) systems are commonly used in many applications, particularly in entertainment and sporting venues. For example, recent race coverage occasionally includes video and audio transmissions from inside a race car. A television audience can then enjoy a view similar to that perceived by the driver and can hear the sounds that the driver makes and hears.

Steele, in a patent family centered on U.S. Pat. No. 7,265,663, teaches systems and methods for obtaining race car telemetry as well as audio and video transmissions from a race car. Far predating Steele, the National Aeronautics and Space Administration (NASA) remotely monitored many aspects of air and space vehicles. NASA telemetry systems provided, and still do provide, mission controllers with sensor measurements of vehicle properties and performance. When the vehicle is a manned vehicle, NASA often uses biometric sensors to monitor the pilots and astronauts so that the mission controllers can gauge the health, performance, and welfare of the people inside the vehicle. One of NASA's early telemetry systems is the S-Band unified system (NASA TM-X55492).

Under the Polar brand, Polar Electro Oy markets a number of biometric sensors of which many are patented. In particular, U.S. Pat. No. 5,690,119 and U.S. Pat. No. 5,632,279 teach systems having a biometric sensor that detects heart beats and wirelessly transmits heartbeat information to a processor. The processor then produces a heart rate measurement. Polar sensors are commonly used to measure the heart rates of runners, cyclists, and other athletes.

As can be inferred, telemetry and biometric telemetry are established technologies. There are, however, barriers to the deployment of telemetry systems in many applications. Returning to the race car example, adding additional systems, including telemetry systems, is opposed by many factors including governing body certification, regulatory compliance, and the nature of professional race teams to field technology only after careful review and testing. Systems and methods for leveraging existing systems for providing telemetry are needed.

### BRIEF SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

It is therefore an aspect of the embodiments that a sensing system produces a sensing stream that is passed to a modulator. The modulator converts the measurement stream into a measurement signal.

It is also an aspect of the embodiments that a video system comprises a transmitter and a receiver. The transmitter has video inputs and audio inputs. The receiver has audio outputs and video outputs. The transmitter transmits radio signals to the receiver. The radio signals can include separate audio and video channels.

It is another aspect of the embodiments that the measurement signal is input into the transmitter and then recovered from the receiver. For example, passing the measurement signal into an audio input on the transmitter results in recovery of the measurement signal from an audio output on the receiver.

It is a further aspect of the embodiments that a demodulator recovers the measurement stream from the measurement signal output by the receiver.

### BRIEF DESCRIPTION OF THE DRAWINGS

The accompanying figures, in which like reference numerals refer to identical or functionally similar elements throughout the separate views and which are incorporated in and form a part of the specification, further illustrate aspects of the embodiments and, together with the background, brief summary, and detailed description serve to explain the principles of the embodiments.

FIG. 1 illustrates biometric telemetry passing from a race car to a television audience in accordance with aspects of the embodiments; and

FIG. 2 illustrates a system that obtains biometric measurements and transmits them over an audio channel in accordance with aspects of the embodiments.

### DETAILED DESCRIPTION

The particular values and configurations discussed in these non-limiting examples can be varied and are cited merely to illustrate at least one embodiment and are not intended to limit the scope thereof. In general, the figures are not to scale.

Telemetry signals and biometric telemetry signals are wirelessly transmitted from an athlete, driver, or other person over an audio/video link. The measurement stream from a sensor can be modulated and then fed into a transmitter's audio input or video input. The transmitter transmits a signal containing the measurement stream as well as audio and video streams. A demodulator recovers the measurement stream output by a receiver receiving the signal. The recovered measurement signal can then be passed to an interested party. For example, a heart rate measurement can be obtained from a driver or other athlete and displayed to a television audience.

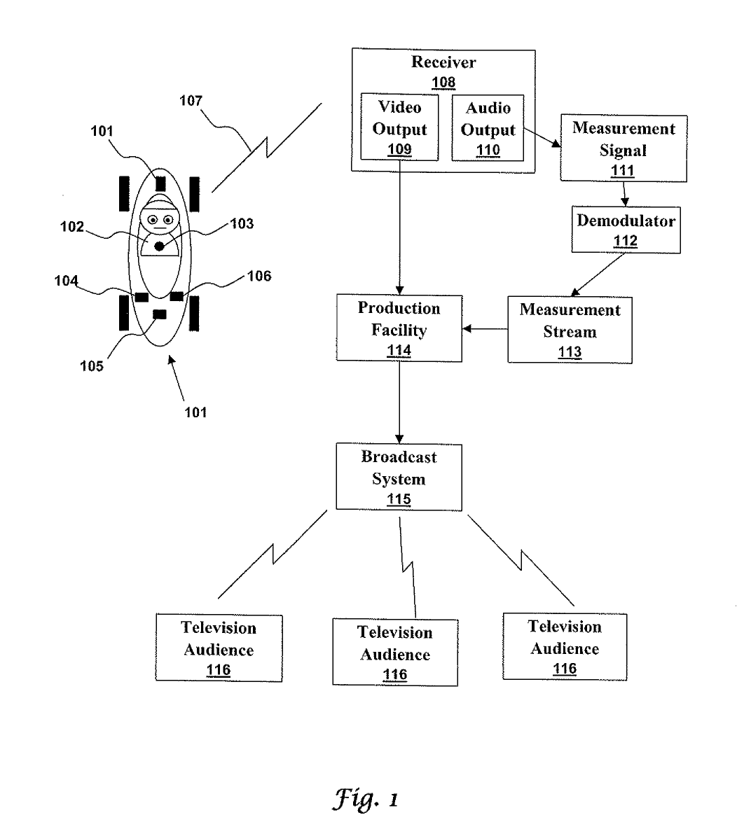

FIG. 1 illustrates biometric telemetry passing from a race car 101 to a television audience in accordance with aspects of the embodiments. A driver 102 is outfitted with a heart beat sensor 103 that wirelessly transmits heart beat information to a processor 104. The heart beat information can be a signal that is transmitted every time a heart beat is detected. The processor 104 can produce a heart rate measurement and pass a measurement stream to a modulator 105. The measurement stream can include heart rate measurements as well as other measurements such as the race car's speed, engine RPM, tire temperatures, driver's skin dampness, driver's temperature, and the race car's cockpit temperature. The sensors for the various measurements can all pass information to the processor 104.

The modulator 104 converts the measurement stream into a measurement signal that is then input into a transmitter 106. In this example, the measurement signal is passed into a transmitter audio input and the transmitter treats the measurement signal as if it were an audio signal. A camera 101 can send a video signal to a transmitter video input. The transmitter sends a radio signal 107 to a receiver 108. The radio signal 107 can have one channel carrying all the transmitted information or can have separate audio and video channels. The receiver 108 converts the radio signal back into the video signal and measurement signals. As with the transmitter 106, the receiver 108 treats the measurement signal as if it were an audio signal. The video signal is output from the video output 109 and the measurement signal 111 is output from the audio output 110.

A demodulator 112 converts the measurement signal 111 back not a measurement stream 113 that can be passed to a production facility 114. A production facility 114 is a facility that typically receives video and audio signals and combines them into a broadcast signal that is then distributed by a broadcast system 115 to a television audience 116.

Here, the production facility 114 obtains video and audio signals as normal but also receives the measurement stream 113. In some embodiments, the production facility 114 receives many measurement streams. For example, measurement streams can be received from many race cars in a particular race. The production personnel can select particular video signals, audio signals and measurements to be combined into the broadcast signal. For example, the broadcast signal can include video from inside a car, audio from a race commentator, and an overlay video graphic indicating the driver's heart rate or an indication of the driver's stress level. Note that those practiced in the art of biometrics are familiar with sensors and sensor suites for gauging stress.

The receiver 108 and the transmitter 106 communicate using radio frequency electromagnetic radiation. The specific frequencies used are governed by national and international rules, laws, and regulations. Internationally, the allocation of radio spectrum is overseen by the International Telecommunication Union (ITU) and most nations have telecommunications laws similar to ITU regulations. Industrial, scientific, and medical (ISM) applications are allocated certain frequencies, called the ISM bands, in which to operate. In the United States, the ISM bands are regulated under 47 CFR §18. Some of the ISM bands are further allocated for certain unlicensed transmissions such as wireless internet and cordless telephony. In the United States, the unlicensed transmissions are regulated under 47 CFR §15.

When operating in conformance with 47 CFR §15 or a similar regulation, the transmitter 106 and receiver 108 can be in an unlicensed mode. When operating in conformance with 47 CFR §18 or a similar regulation, the transmitter 106 and receiver 108 can be in a licensed mode. In practice, the unlicensed mode transmitter/receiver pairs are more common and less expensive but typically have shorter transmission ranges.

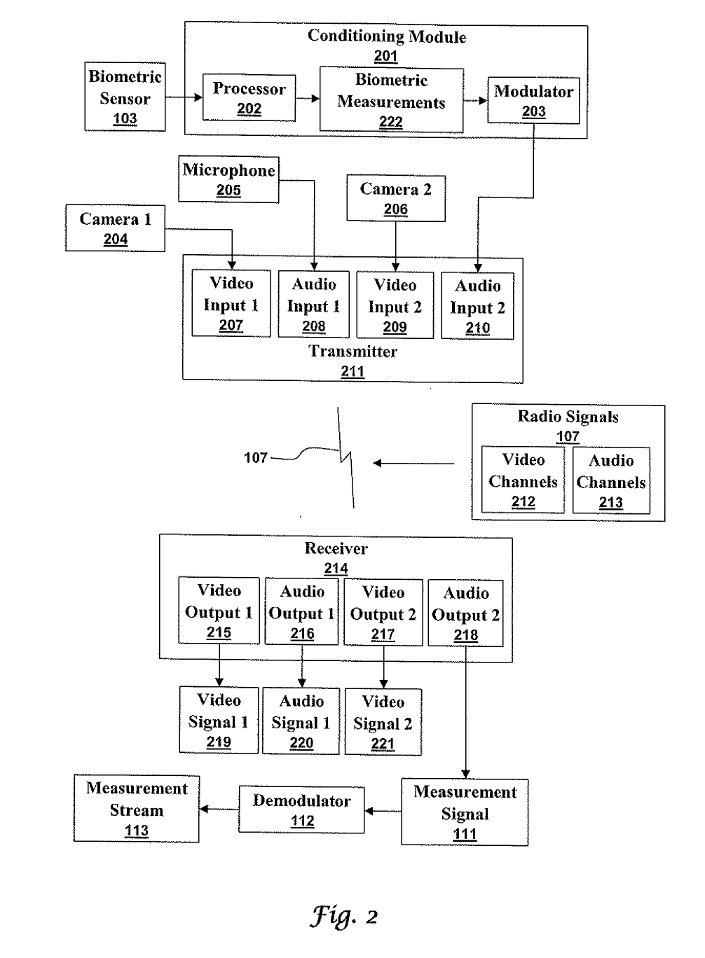

FIG. 2 illustrates a system that obtains biometric measurements and transmits them over an audio channel in accordance with aspects of the embodiments. A processor 202 uses information obtained from a biometric sensor 103 to produce biometric measurements 222. A modulator 203 converts the biometric measurements 222 into a measurement stream. Note that in FIG. 2, a conditioning module 201 includes the processor 202 and the modulator 203. The reason is that a single hardware unit can perform many tasks including those performed by the processor 202 and the modulator 203.

A transmitter having multiple video and audio inputs can receive many signals. The transmitter 211 is illustrated as receiving video signal 1 from camera 1 204 into video input 1 207. A microphone 205 supplies audio signal 1 to audio input 1 208. A second camera 206 supplies video signal 2 to video input 2 209. The measurement signal passes into audio input 2 210. The transmitter 211 emits a radio signal 107 that is received by a receiver 214. The radio signal 107 can have video channels 212 and audio channels 213.

The receiver 214 recovers the video and audio signals from the radio signal 107. Video signal 1 219 is output from video output 1 215. Audio signal 1 220 is output from audio output 1 216. Video output 2 217 outputs video signal 2 221. Audio output 2 218 outputs the measurement signal 111. A demodulator 112 converts the measurement signal 111 into a measurement stream 113.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

The embodiments of the invention in which an exclusive property or right is claimed are defined as follows. Having thus described the invention what is claimed is:

1. A system comprising:
at least one sensing system and at least one measurement stream wherein the at least one sensing system produces the at least one measurement stream;
a modulator that converts the at least one measurement stream into at least one measurement signal;
a demodulator that recovers the at least one measurement stream from the at least one measurement signal; and
a video system comprising a transmitter and a receiver wherein the transmitter comprises inputs comprising at least one video input and at least one audio input, and wherein the receiver comprises outputs comprising at least one video output and at least one audio output, wherein the transmitter transmits radio signals to the receiver;
wherein the modulator passes the at least one measurement signal to one of the inputs, and wherein the demodulator receives the measurement signal from one of the outputs and recovers the measurement stream.

2. The system of claim 1 wherein the modulator passes the at least one measurement signal to one of the audio inputs, and wherein the demodulator receives the measurement signal from one of the audio outputs.

3. The system of claim 1 wherein the transmitter transmits the measurement signal to the receiver over the video channel.

4. The system of claim 1 further comprising a vehicle wherein the at least one sensing system, the modulator, and the transmitter are inside or attached to the vehicle.

5. The system of claim 4 wherein the vehicle is a race car.

6. The system of claim 1 further comprising a video camera supplying a video signal to the at least one video input wherein the recovered measurement stream is passed to a production facility and thence to a television audience.

7. The system of claim 1 wherein the radio signals comprise at least two channels comprising a video channel and an audio channel.

8. A system comprising:
a biometric sensor transmitting a biometric signal to a processor that produces a biometric data stream comprising a plurality of biometric measurements;
a modulator that converts the at least one biometric data stream into at least one biometric data signal;
a demodulator that recovers the at least one biometric data stream from the at least one biometric data signal; and
a video system comprising at least one video input and at least one audio input, a transmitter, and a receiver wherein the transmitter transmits radio signals to the receiver and wherein the radio signals comprise at least two channels comprising a video channel and an audio channel;
wherein the modulator passes the at least one biometric data signal to the transmitter, wherein the transmitter transmits the biometric data signal to the receiver, and wherein the demodulator receives the biometric data signal from the receiver and recovers the biometric data stream.

9. The system of claim 8 wherein the transmitter transmits the measurement signal to the receiver over the audio channel.

10. The system of claim 8 wherein the transmitter transmits the measurement signal to the receiver over the video channel.

11. The system of claim 8 further comprising a race car wherein the processor, the modulator, and the transmitter are inside or attached to the vehicle.

12. The system of claim 8 wherein the biometric sensor wirelessly transmits the biometric signal to the processor.

13. The system of claim 12 further comprising:
a race car wherein the biometric sensor the processor, the modulator, and the transmitter are inside or attached to the vehicle; and
a video camera supplying a video signal to the at least one video input;
wherein the transmitter transmits the measurement signal to the receiver over the audio channel;
wherein the recovered measurement stream is passed to a production facility and thence to a television audience.

14. A system comprising:
a means for producing a measurement stream;
a video system comprising a transmitter and a receiver wherein the transmitter comprises inputs comprising at least one video input and at least one audio input, and wherein the receiver comprises outputs comprising at least one video output and at least one audio output, wherein the transmitter transmits radio signals to the receiver;
a means for converting the measurement stream into a measurement signal wherein the measurement signal is input into the transmitter; and
a means for recovering the measurement stream from the receiver.

15. The system of claim 14 further comprising a biometric sensor transmitting a biometric signal to a processor that produces the measurement stream wherein the measurement stream comprises a plurality of biometric measurements.

16. The system of claim 15 wherein the measurement signal is input into one of the at least one audio input.

17. The system of claim 16 further comprising a vehicle wherein the processor and the transmitter are inside or attached to the vehicle.

18. The system of claim 17 wherein the vehicle is a race car.

19. The system of claim 18 wherein the biometric sensor is attached to a driver and wherein the driver drives the race car.

20. The system of claim 19 further comprising a means for supplying a video signal to the at least one video input and wherein the recovered measurement stream is passed to a production facility and thence to a television audience.
